(19) United States
(12) Patent Application Publication
(10) Pub. No.: US 2020/0361276 A1
(43) Pub. Date: Nov. 19, 2020

(54) Heating, Ventilation, And Air Conditioning (HVAC) System

(71) Applicant: DENSO CORPORATION, Kariya-city (JP)

(72) Inventor: Michael BIMA, Milford, MI (US)

(21) Appl. No.: 16/659,048

(22) Filed: Oct. 21, 2019

Related U.S. Application Data
(60) Provisional application No. 62/848,774, filed on May 16, 2019.

(51) Int. Cl. B60H 1/00; B60N 2/56

(52) U.S. Cl. CPC B60H 1/00285; B60N 2/5628

(57) ABSTRACT

A seat having a heating, ventilation, and air conditioning (HVAC) unit attached thereto includes a base, an aperture, and an activation point. The base has at least one channel therein. The at least one channel receives airflow from the HVAC unit. The aperture is disposed in a surface of the base and in fluid communication with the at least one channel. The activation point provides selective communication through the aperture.

### CROSS-REFERENCE TO RELATED APPLICATIONS

This application claims the benefit of U.S. Provisional Application No. 62/848,774, filed on May 16, 2019. The entire disclosure of the above application is incorporated herein by reference.

### FIELD

The present disclosure relates to a heating ventilation and air conditioning (HVAC) system, and, more specifically, heating and cooling management for an HVAC system.

### BACKGROUND

This section provides background information related to the present disclosure which is not necessarily prior art.

Heating, ventilation, and air conditioning (HVAC) systems, especially in vehicles, typically include a condenser and an evaporator located in one space, such as the engine compartment, and a fan or blower located in a separate space, such as in the dashboard. However, these types of HVAC systems are large and cannot be configured for use in small spaces, such as, for example, spaces found on a bicycle.

### SUMMARY

This section provides a general summary of the disclosure, and is not a comprehensive disclosure of its full scope or all of its features.

An example embodiment of a seat according to the present disclosure has a heating, ventilation, and air conditioning (HVAC) unit attached thereto. The seat includes a base, an aperture, and an activation point. The base has at least one channel therein. The at least one channel receives airflow from the HVAC unit. The aperture is disposed in a surface of the base and in fluid communication with the at least one channel. The activation point provides selective communication through the aperture.

In an example embodiment, the activation point may be a stopper. The stopper may be engaged with a sidewall defining the aperture to prevent fluid communication through the aperture. The stopper may be disengaged from the sidewall to permit fluid communication through the aperture.

In an example embodiment, the stopper may be a ball stopper.

In an example embodiment, the stopper may be formed of an elastic material.

In an example embodiment, the seat may further include a biasing member for biasing the stopper into engagement with the sidewall.

In an example embodiment, the biasing member may be a fluid-filled chamber.

In an example embodiment, the fluid-filled chamber may include a rubber housing.

In an example embodiment, the biasing member may be a spring.

In an example embodiment, the spring may be a helical spring.

In an example embodiment, the spring may be disposed within a chamber in the stopper.

In an example embodiment, the spring may be disposed external to the stopper.

In an example embodiment, the activation point may be a pad containing an air release slit. The air release slit may be in a closed position to prevent fluid communication through the aperture. The air release slit may be in an open position to permit fluid communication.

In an example embodiment, the pad may include a dimple. The air release slit may be disposed at a center of the dimple.

In an example embodiment, the dimple may project through the aperture. The dimple may contact the sidewall to create a seal between the dimple and the sidewall. The dimple may be biased to project through the aperture to prevent airflow from flowing through the aperture.

In an example embodiment, when the dimple is compressed, the slit may open into an aperture, permitting fluid communication therethrough.

In an example embodiment, a periphery of the pad may be fixed to an inner wall of the at least one channel around the sidewall defining the aperture.

In an example embodiment, the seat may further include a plurality of the aperture and a plurality of the activation point.

In an example embodiment, the seat may further include a seat back including a portion of the plurality of the aperture and a portion of the plurality of the activation point.

An example embodiment of a bicycle according to the present disclosure includes a frame, a seat, and a self-contained heating, ventilation, and air conditioning (HVAC) unit. The seat and HVAC unit are supported by the frame. The HVAC unit provides airflow to the seat. The seat includes a base having at least one channel therein that receives airflow from the HVAC unit. An aperture is disposed in a surface of the base and is in fluid communication with the at least one channel. An activation point provides selective communication through the aperture.

An example embodiment of a bicycle according to the present disclosure includes a frame, a seat, and a self-contained heating, ventilation, and air conditioning (HVAC) unit. The seat and HVAC unit are supported by the frame. The HVAC unit provides airflow to the seat. The seat includes a base having at least one channel therein. The at least one channel receives airflow from the HVAC unit. The base is formed of an exoskeleton frame.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example bicycle having an example embodiment of an HVAC system according to the present disclosure.

FIG. 2 is a schematic view of the example bicycle shown in FIG. 1 without a body.

FIG. 3 is a perspective view of an example embodiment of a miniature HVAC unit for use in the example bicycle shown in FIG. 1.

FIG. 4 is a perspective view of the miniature HVAC unit shown in FIG. 3 with a lid removed.

FIG. 5A is a perspective view of an example exoskeleton used to form a seat of the bicycle shown in FIG. 1.

FIG. 5B is a perspective view of an example exoskeleton having apertures used to form a seat of the bicycle shown in FIG. 1.

FIG. 6 is a perspective view of an example pad-style seat of the bicycle shown in FIG. 1.

FIG. 7 is a perspective view of an example traditional-style seat of the bicycle shown in FIG. 1.

FIG. 8A is a schematic view of an example point actuator for a seat of the bicycle shown in FIG. 1.

FIG. 8B is another schematic view of the example point actuator shown in FIG. 8A.

FIG. 9A is a schematic view of another example point actuator for a seat of the bicycle shown in FIG. 1.

FIG. 9B is another schematic view of the example point actuator shown in FIG. 9A.

FIG. 10A is a schematic view of another example point actuator for a seat of the bicycle shown in FIG. 1.

FIG. 10B is another schematic view of the example point actuator shown in FIG. 10A.

FIG. 11A is a top schematic view of another example point actuator for a seat of the bicycle shown in FIG. 1.

FIG. 11B is a side schematic view of the example point actuator shown in FIG. 11A.

FIG. 11C is another top schematic view of the example point actuator shown in FIG. 11A.

FIG. 11D is a side schematic view of the example point actuator shown in FIG. 11B.

FIG. 12 is a rear perspective view of an example nozzle for use in the example bicycle shown in FIG. 1.

FIG. 13 is a front perspective view of the example nozzle shown in FIG. 12.

FIG. 14 is a schematic view of a cross-section of the nozzle shown in FIG. 12 cut along a plane through a longitudinal axis of the nozzle.

FIG. 15 is a computational fluid dynamics diagram of nozzle flow for the nozzle shown in FIG. 12.

FIG. 16 is a graph illustrating a normalized nozzle velocity profile comparing a nozzle having a cylindrical rod and spike versus a nozzle without the cylindrical rod and spike.

FIG. 17 is a perspective view of an example vertical support section of the example bicycle shown in FIG. 1 including a plurality of the nozzles shown in FIG. 12.

FIG. 18 is a perspective view of an example dashboard of the example bicycle shown in FIG. 1 including a plurality of the nozzles shown in FIG. 12.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A persuasive electric vehicle (PEV) is an autonomous bicycle that has a traditionally open cockpit, but also includes a windscreen. A miniaturized, all-in-one package of a conventional vehicle HVAC system, such as a miniature, self-contained heating, ventilation, and air conditioning (HVAC) system may be utilized in the PEV to provide heating and cooling airflow. The goal is to provide increased comfort to the rider of the PEV in both hot and cold conditions, especially in cases where the rider must pedal the bicycle and could get hot. The miniature, self-contained HVAC system may cooperate with different seat structures and/or nozzles and/or other HVAC system accessories to provide heating or cooling comfort to the occupant via forced conditioned airflow from the miniature, self-contained HVAC system.

Denso Corporation has developed a miniature, self-contained HVAC unit for such purposes marketed as the NOTEBOOK AC™. Details of the miniature, self-contained HVAC unit can be found in Japanese Patent Number 3858744 and Japanese Patent Application Numbers 2018-173867, 2016-023028, 2019-36224, 2019-092293, 2019-20904, 2019-795, 2018-234595, 2018-219806, 2018-216356, 2018-216354, 2018-216355, 2017-120149, 2018-089387, 2018-071870, 2018-243392, 2015-023615, 2015-014553, 2017-1406792018-118588, 2019-018774, and 2019-16122. The details of the Japanese Patent and applications are incorporated herein by reference.

The NOTEBOOK AC™ includes an entire HVAC refrigeration cycle (compressor, refrigerant, evaporator, condenser, expansion valve, blower motors, mixing chamber, blend doors, etc.) “miniaturized” in an all-in-one package. The NOTEBOOK AC™ is capable of providing heating and cooling airflow. For cooling, the air is pulled off of the evaporator, and for heating, the air is pulled off of the condenser. Additionally, the air paths can be mixed to create a variety of temperatures.

The different seat structures may include an exoskeleton seat, a pad-style seat, or a traditional-style seat. The exoskeleton seat may provide heating or cooling comfort by either conduction or by venting air. The pad-style seat and traditional-style seat may provide heating or cooling comfort by venting air. The pad-style seat and traditional-style seat may additionally include multiple zones or activation points within the seat to improve comfort and efficiency. Only portions of the person's body in contact with the seat surface will activate the airflow. These are pressure or contact actuated zones that tailor the comfort of the system to each person's individual body type or seating position. The multiple zones or activation points can be accomplished by ball or slit style systems. The airflow activation zones can also be utilized for other applications such as automotive seating, airplane seating, movie theater seating, theme park seating, etc. Additionally the waste air can be used to cool the autonomous drive computers and other components such as the battery by ducting the airflow through the frame of the bicycle.

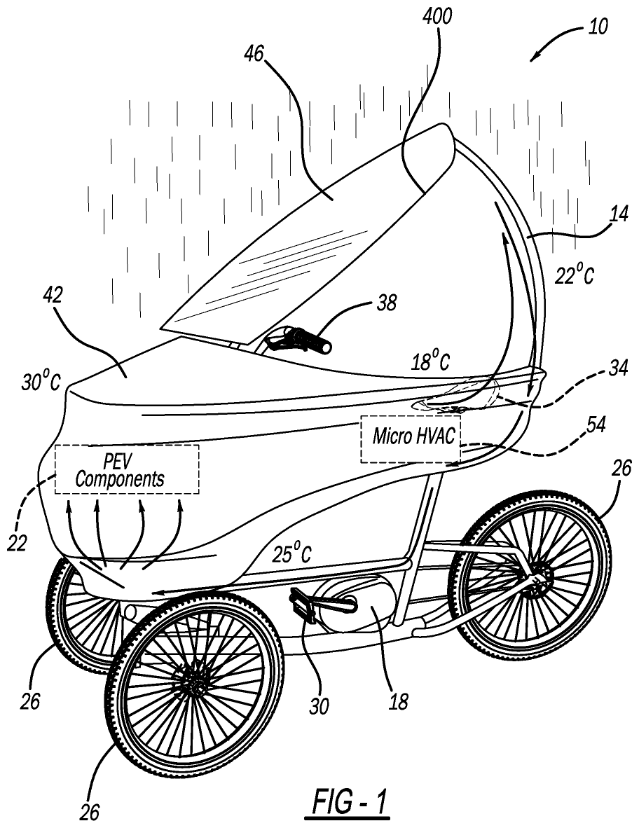

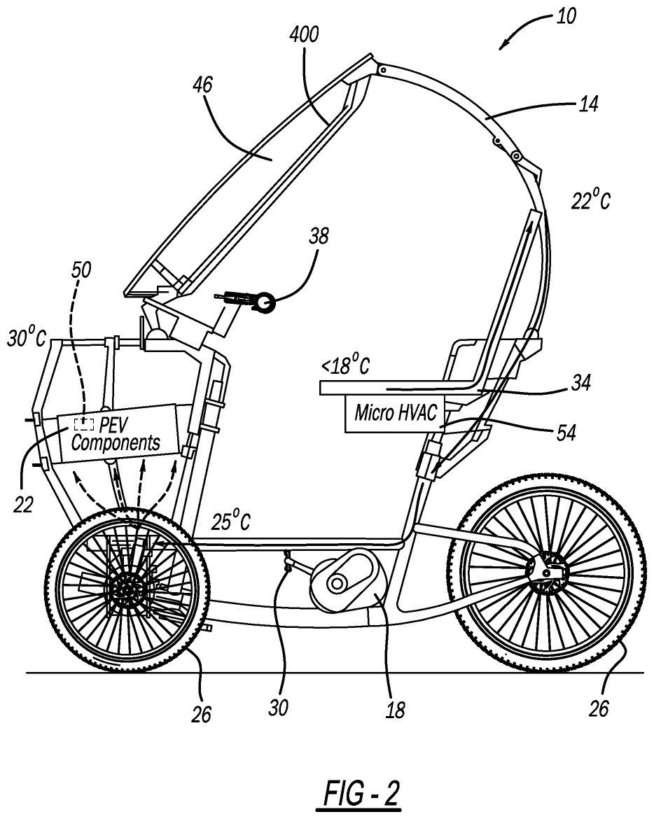

Referring to FIGS. 1 and 2, an example embodiment of a bicycle 10 is illustrated. In an example embodiment, the bicycle 10 may be an autonomous bicycle and may include a frame 14, a motor 18, electrical components 22, wheels 26, pedals 30, a seat 34, handle bars 38, and a body 42. The frame 14 may support the motor 18, electrical components 22, wheels 26, pedals 30, seat 34, handle bars 38, and body 42, and may additionally support a windshield 46, in some embodiments. The frame 14 may be a tubular frame having a circular cross-section, a square cross-section, or any other shaped cross-section. The frame 14 may be formed of metal (for example, steel), composite (for example, carbon fiber), plastics, or other suitable materials.

The bicycle 10 may additionally include a control system 50 that controls the various components to autonomously operate the bicycle 10. For example, the control system 50 may control operation of the motor 18 to cooperate with a user's operation of the pedals 30. The motor 18 drives the wheels 26 to propel the bicycle 10.

The body 42 may be an open cockpit that surrounds the frame 14 and user to protect the user during operation of the bicycle 10. The body 42 may be formed of metal (for example, aluminum, steel, etc.), composite (for example, carbon fiber), plastics, or other suitable materials. The body 42 may be a single, unitary piece or may be formed of several panels.

A heating, ventilation, and air conditioning (HVAC) unit 54 may be mounted to the frame 14 or seat 34 to provide heating or cooling comfort to the user via forced conditioned airflow from the HVAC unit 54. The HVAC unit 54 may be a miniature HVAC unit 54, able to fit in smaller spaces (such as under the seat of a bicycle, a movie theater seat, stadium seat, vehicle seat, theme park seat, etc., for example). For example, in some embodiments, a size of the miniature HVAC unit 54 may be equal to about a size of a ream of paper.

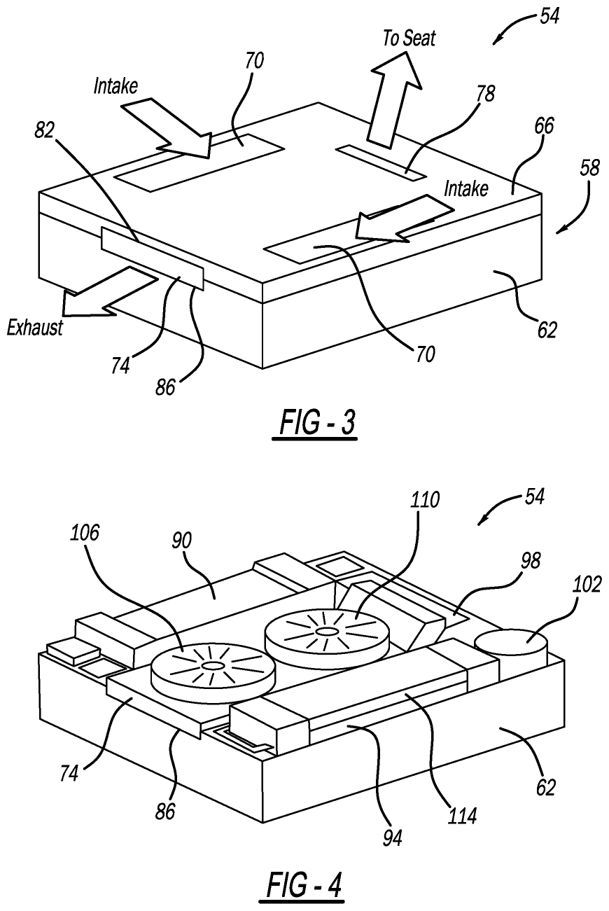

Now referring to FIGS. 3-4, an example embodiment of the HVAC unit 54 is illustrated. The HVAC unit 54 is a self-contained HVAC unit, enclosed within a package 58. The package 58 includes a base 62 and a lid 66. The package 58 includes a number of apertures for airflow. For example, the package 58 includes intake apertures 70, an exhaust aperture 74, and an airflow aperture 78. The intake apertures 70 and airflow aperture 78 may be formed within the lid 66. A notch 82 in the lid 66 and a notch 86 in the base 62 may cooperate to define the exhaust aperture 74 when assembled.

The HVAC unit 54 may be a dual-fan, sucking-type HVAC unit having a condenser 90, an evaporator 94, a compressor 98, an accumulator 102, and two fans 106, 110. The first fan 106 may be an exhaust fan, for directing airflow to the exhaust aperture 74. The second fan 110 may be a fan that directs air from one or both of the condenser 90 and the evaporator 94 to the airflow aperture 78.

One intake aperture 70 is positioned above the evaporator 94 and one intake aperture 70 is positioned above the condenser 90. Air filters 114 may separate the intake apertures 70 from the internal components of the HVAC unit 54. According to the principles of the present disclosure, the HVAC unit 54 may include additional and/or alternative components, such as an expansion valve or other valves, various sensors, heat exchangers, fans, or any other additional and/or alternative components.

A fluid, for example, refrigerant, is circulated through the HVAC unit 54. The compressor 98 provides pressurized refrigerant in vapor form to the condenser 90. All or a portion of the pressurized refrigerant is converted into liquid form within the condenser 90. The condenser 90 transfers heat away from the refrigerant, thereby cooling the refrigerant and transforming the refrigerant into a liquid. The condenser 90 provides the refrigerant to the evaporator 94. The refrigerant absorbs heat in the evaporator 94 and transitions from a liquid to a vapor form. The evaporator 94 provides the refrigerant in vapor form back to the compressor 98.

A user may select whether the HVAC unit 54 blows warm air, cold air, or a mixture of warm and cold air out of the airflow aperture 78. In operation, the HVAC unit 54 sucks air into the package 58 through the intake apertures 70. As the air is sucked into the package 58, it flows past the respective evaporator 94 and condenser 90, either cooling or heating the air. Based on the user's selection, warm air and/or cold air from the condenser 90 and/or evaporator 94, respectively, is routed through the second fan 110 and directed out the airflow aperture 78. The remaining warm air and/or cold air from the condenser 90 and/or evaporator 94, respectively, is routed through the first fan 106 and out the exhaust aperture 74. A series of mixing chambers, airflow channels, and blend doors may accurately mix the warm air and/or cold air to the desired temperature. Thus, the HVAC unit 54 is a self-contained unit that provides selective heating and cooling.

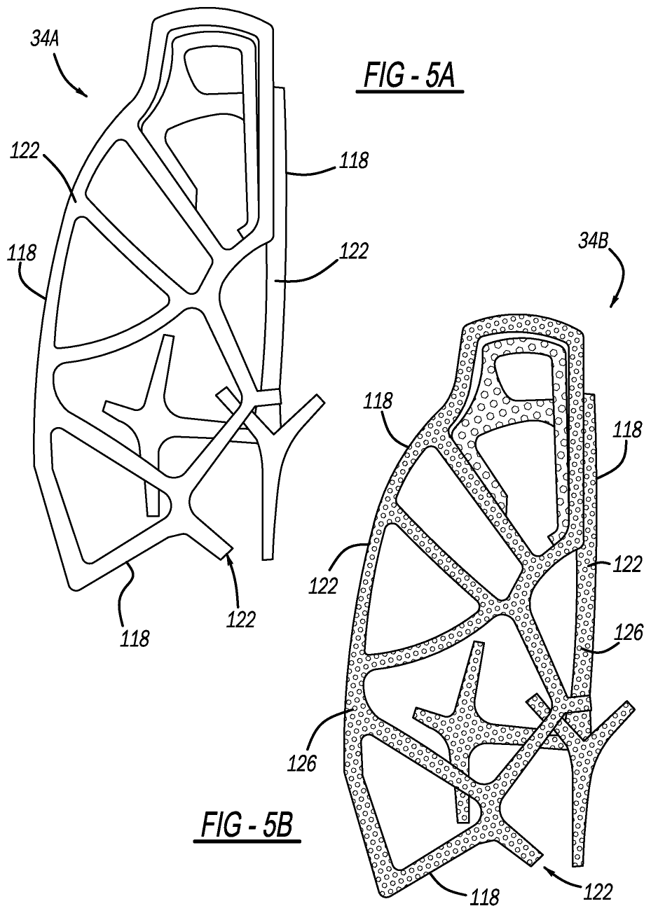

The HVAC unit 54 may be connected to the seat 34 structure to provide heating or cooling comfort to the user. Referring to FIGS. 5A-7, the seat 34 may be formed of an exoskeleton seat 34A, 34B, may be a pad-style seat 34C, or may be a traditional-style seat 34D. As shown in FIGS. 5A and 5B, the exoskeleton 34A, 34B may be a series of tubular pieces 118 formed as a single, monolithic piece. A channel 122 within the tubular pieces 118 is in fluid communication with the airflow aperture 78 of the HVAC unit 54 and receives cold, warm, and/or mixed air from the HVAC unit 54.

In an example embodiment, the user may receive the heating or cooling comfort by direct contact, or conduction, with the exoskeleton 34A (see FIG. 5A). As the cold, warm, and/or mixed air from the HVAC unit 54 is routed or guided through the channel 122 in the tubular pieces 118, the heat or cold is transferred from the air to the user.

In another example embodiment of the exoskeleton 34B, the tubular pieces 118 contain small apertures 126 (see FIG. 5B). The user may receive the heating or cooling comfort through the vent system in the exoskeletion 34B. The cooled, heated, and/or mixed air is released from the channel 122 through the apertures 126 and blown on the user.

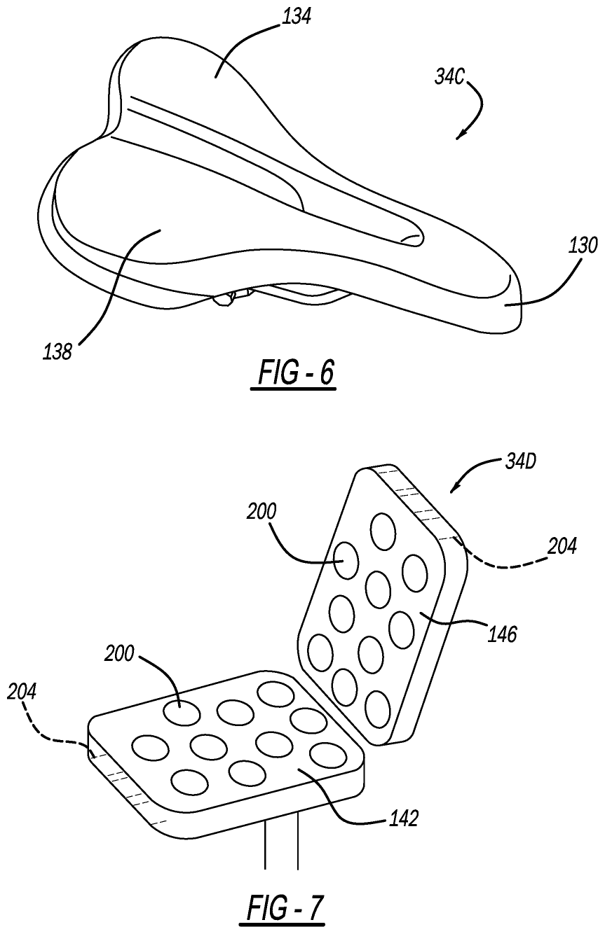

As shown in FIG. 6, the seat 34 may be the pad-style seat 34C. The pad-style seat 34C may be a single-pad seat, a twin-pad seat, or a saddle seat (not illustrated). The pad-style seat 34C may include a nose support 130, a left side support 134, and a right side support 138. While the pad-style seat 34C is illustrated as a single piece, it is understood that the pad-style seat 34C illustrated is merely an example and could have different positions/thickness/firmness of padding or different seat shape. Additionally, the pad-style seat 34C may be divided into separate sections and/or may be adjustable to change shape or support for different riders.

As shown in FIG. 7, the seat 34 may be the traditional-style seat 34D. The traditional-style seat 34D may include a base 142 and a back 146. The base 142 and back 146 may be joined or separate.

Additionally referring to FIG. 7, the pad-style seat 34C or traditional-style seat 34D may include airflow activation points, or airflow activators, 200. The airflow activation points 200 may provide a fluid communication between channels 204 in the seat 34 and the atmosphere and/or user. When activated, the airflow activation points 200 vent heated, cooled, and/or mixed air from the channels 204 to heat or cool the user.

The airflow activation points 200 may be randomly dispersed or dispersed in a pattern over a surface area of the pad-style seat 34C or the base 142 and/or back 146 of the traditional-style seat 34D. Additionally, the airflow activation points 200 may be more congested in some areas (for example in a space occupied by 5%-95% of users) and more sparse in some areas (for example, in the spaces not occupied by 5%-95% of users). The airflow activation points 200 may be activated from a closed state where airflow does not escape to an open state where airflow is vented. In the closed state, the airflow surpasses the airflow activation point 200 in the channel 204. In the open state, the airflow is vented from the channel 204 through an aperture 208 in the airflow activation point 200.

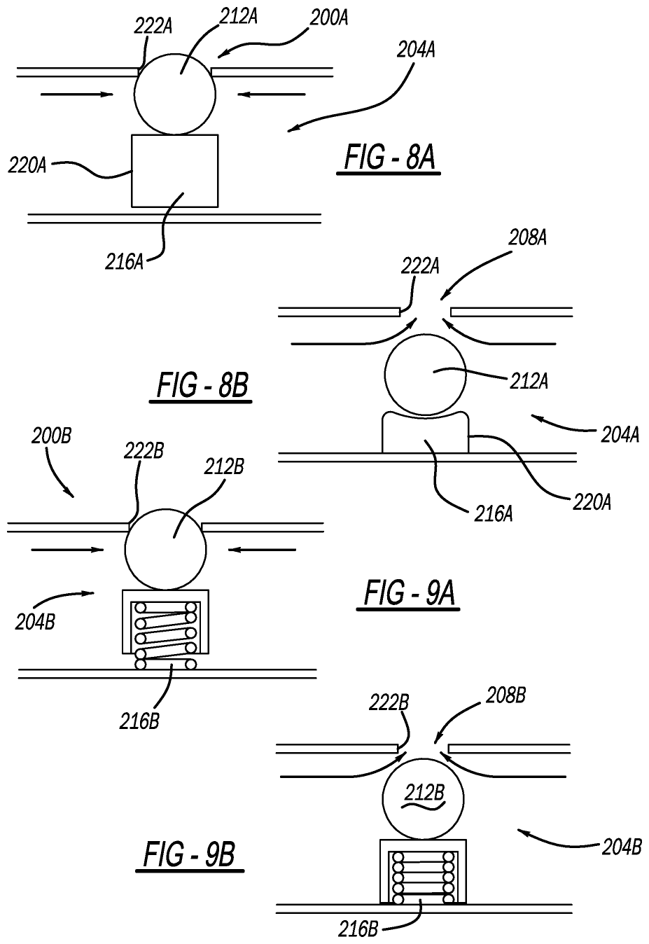

As shown in FIGS. 8A-11D, the airflow activation points 200 may take on a number of example embodiments. In an example embodiment, FIGS. 8A and 8B illustrate an airflow activation point 200A. Airflow activation point 200A may be a ball-type airflow activation point having a stopper 212A and a biasing member 216A. For example, the stopper 212A may be a ball-type stopper and the biasing member 216A may be a fluid-filled chamber. The stopper 212A may be formed of a rubber, foam, plastic, or other cushioning material to be comfortable for the user to activate. The fluid-filled chamber 216A may include a housing 220A. Housing 220A may be a deformable housing formed from a rubber, or other elastic material. The housing 220A may contain a fluid (not illustrated) that is water, or other inexpensive fluid.

During use, the stopper 212A protrudes through an aperture 208A and engages a sidewall 222A defining the aperture 208A to form a seal around the aperture 208A. Heated, cooled, and/or mixed air flows through the channel 204A and bypasses the sealed aperture 208A. When the user sits on the seat 34, the user contacts the stopper 212A and compresses the stopper 212A and biasing member 216A into the channel 204A, breaking the seal between the stopper 212A and the aperture 208A. With the stopper 212A no longer protruding through the aperture 208A, the heated, cooled, and/or mixed air is free to vent/flow through the aperture 208A and to the user.

When the user stands, or gets off the seat 34, the user no longer contacts the stopper 212A (or applies pressure to the stopper 212A) and the biasing member 216A returns the stopper 212A to its original position, into engagement with the sidewall 222A of the aperture 208A and protruding through the aperture 208A. This restores the seal between the stopper 212A and the aperture 208A. The heated, cooled, and/or mixed air flows through the channel 204A and bypasses the sealed aperture 208A.

In an example embodiment, FIGS. 9A and 9B illustrate an airflow activation point 200B. Airflow activation point 200B may be a ball-type airflow activation point having a stopper 212B and a biasing member 216B. For example, the stopper 212B may be a ball-type stopper and the biasing member 216B may be an external spring. The stopper 212B may be formed of a rubber, foam, plastic, or other cushioning material to be comfortable for the user to activate. The external spring 216B may be a helical spring and formed from a plastic, metal, or other suitable material.

During use, the stopper 212B protrudes through the aperture 208B and engages a sidewall 222B defining the aperture 208B to form a seal around the aperture 208B. Heated, cooled, and/or mixed air flows through the channel 204B and bypasses the sealed aperture 208B. When the user sits on the seat 34, the user contacts the stopper 212B (and applies pressure thereto) and compresses the stopper 212B and biasing member 216B into the channel 204B. This breaks the seal between the stopper 212B and the aperture 208B. With the stopper 212B no longer protruding through the aperture 208B, the heated, cooled, and/or mixed air is free to vent/flow through the aperture 208B and to the user.

When the user stands, or gets off the seat 34, the user no longer contacts the stopper 212B (and no longer applies pressure thereto) and the biasing member 216B returns the stopper 212B to its original position, into engagement with the sidewall 222B of the aperture 208B and protruding through the aperture 208B. This restores the seal between the stopper 212B and the aperture 208B. The heated, cooled, and/or mixed air flows through the channel 204B and bypasses the sealed aperture 208B.

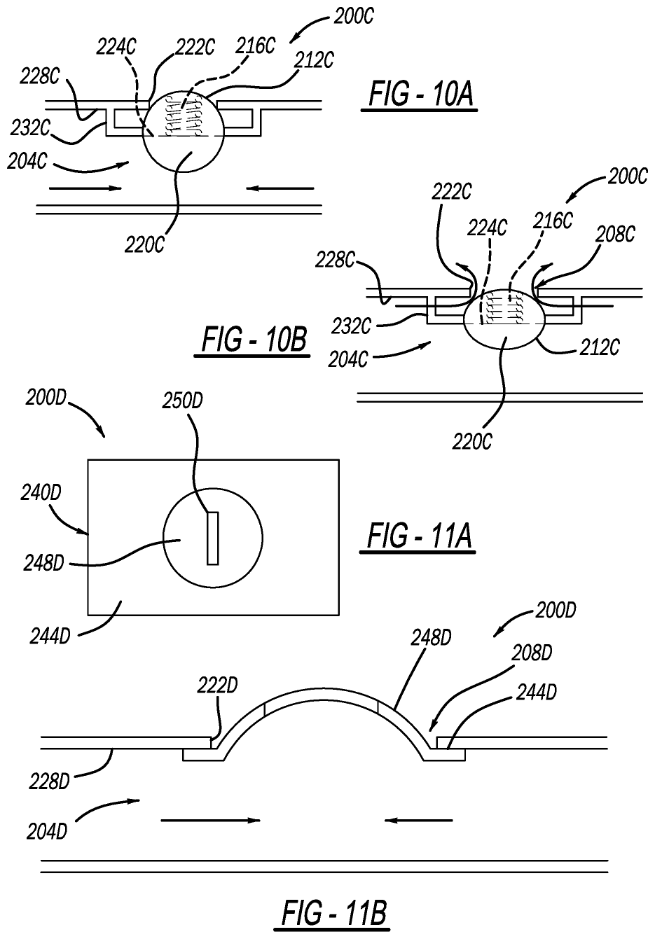

In an example embodiment, FIGS. 10A and 10B illustrate an airflow activation point 200C. Airflow activation point 200C may be a ball-type airflow activation point having a stopper 212C and a biasing member 216C. For example, the stopper 212C may be a ball-type stopper and the biasing member 216C may be an internal spring. The internal spring 216C may be positioned inside a cavity 220C within the stopper 212C. In some embodiments, the internal spring 216C may be fixed to a wall or partition 224C that divides the stopper 212C into sections.

The stopper 212C may be fixed to an interior wall 228C defining the channel 204C by arms 232C. In some embodiments, two arms 232C may fix the stopper 212C to the interior wall 228C adjacent to an aperture 208C. Each of the two arms 232C may be fixed to opposing sides of the stopper 212C and may extend at a right angle to fix the stopper 212C to the interior wall 228C. The stopper 212C may be formed of a rubber, foam, plastic, or other cushioning material to be comfortable for the user to activate. The internal spring 216C may have a helical structure and may be formed of a metal, plastic, or other suitable material. The arms 232C may either be rigid or flexible and may be formed of a metal, plastic, rubber, or other suitable material. In an embodiment where the arms 232C are flexible, the arms 232C may be formed of a same material as the stopper 212C and may be integral with the stopper 212C, forming a monolithic piece.

During use, the stopper 212C engages a sidewall 222C defining the aperture 208C and projects from the aperture 208C to form a seal between the stopper 212C and the aperture 208C. Heated, cooled, and/or mixed air flows through the channel 204C and bypasses the sealed aperture 208C. When the user sits on the seat 34, the user contacts the stopper 212C (and applies pressure thereto) and compresses the stopper 212C and biasing member 216C. The stopper 212C deforms (for example, squishes) to no longer protrude through the aperture 208C. This breaks the seal between the stopper 212C and the aperture 208C. With the stopper 212C no longer protruding through the aperture 208C, the heated, cooled, and/or mixed air is free to vent/flow through the aperture 208C and to the user.

With the biasing member 216C being disposed in the cavity 220C within the stopper 212C, only a portion of the stopper 212C may be deformed and compressed to break the seal between the stopper 212C and the sidewall 222C of the aperture 208C. If the internal spring 216C is disposed on a wall or partition 224C in the cavity 220C, less of the stopper 212C may be deformed than if the biasing member 216C is disposed, for instance, on a bottom side of the cavity 220C.

When the user stands, or gets off the seat 34, the user no longer contacts the stopper 212C (and no longer applies pressure thereto) and the biasing member 216C returns the stopper 212C to the original position, into engagement with the sidewall 222C of the aperture 208C and protruding through the aperture 208C. This restores the seal between the stopper 212C and the sidewall 222C of the aperture 208C. The heated, cooled, and/or mixed air flows through the channel 204C and bypasses the sealed aperture 208C.

With the biasing member 216C being disposed in the cavity 220C of the stopper 212C, only the portion of the stopper 212C that was previously deformed and compressed is returned to its original shape. As previously mentioned, if the internal spring 216C is disposed on a wall or partition 224C in the cavity 220C, less of the stopper 212C must be returned to its original state by the biasing member 216C as compared to, for example, an embodiment where the biasing member 216C is disposed on a bottom side of the cavity 220C.

In an example embodiment, the stopper 212C may not include an internal spring, but instead be formed of an elastic material, such as rubber, that has biasing properties. When the user sits on the seat 34, the user contacts the stopper 212C (and applies pressure thereto) and compresses the stopper 212C. This breaks the seal between the stopper 212C and the sidewall 222C of the aperture 208C. The heated, cooled, and/or mixed air is then free to vent/flow through the aperture 208C into the user.

When the user stands, or gets off the seat 34, the user no longer contacts the stopper 212C and the stopper 212C, having a biasing material, returns to its original shape and into engagement with the aperture 208C. This restores the seal between the stopper 212C and the aperture 208C. The heated, cooled, and/or mixed air flows through the channel 204C and bypasses the sealed aperture 208C.

An advantage to having an internal biasing member (or no biasing member), such as biasing member 216C, is that there is no biasing member disposed within the channel 204C. A clear airflow path through the channel 204C leads to an increased airflow space and constant pressure (i.e, no pressure drop). Thus, the internal biasing member 216C provides for more efficient airflow within the channel 204C.

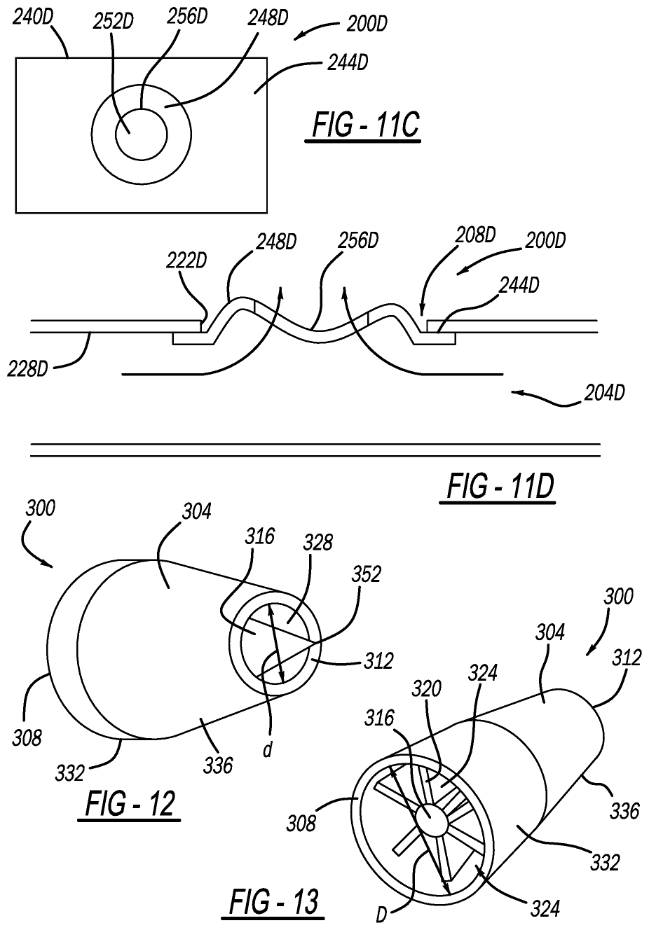

In an example embodiment, FIGS. 11A, 11B, 11C, and 11D illustrate an airflow activation point 200D. Airflow activation point 200D may be a dimple-type airflow activation point and may include a pad 240D disposed within aperture 208D. Pad 240D may be sized to be larger than aperture 208D so as to prevent pad 240D from slipping out of aperture 208D. A periphery 244D of pad 240D may be fixed to an interior wall 228D defining channel 204D around aperture 208D. For example, the periphery 244D may be fixed to the interior wall 228D by an adhesive. The pad 240D may be formed of rubber, plastic, another elastic material, or another suitable material.

The pad 240D may include a dimple 248D disposed at a center 252D of pad 240D. Dimple 248D may be a circular dimple 248D having a cone-like shape. Dimple 248D may be formed from a same material as the periphery 244D of pad 240D and may be formed integrally to the periphery 244D, such that pad 240D is a single, monolithic piece.

In an alternative embodiment, the dimple 248D may be formed of a different material from periphery 244D and may be fixed to the periphery 244D, such as by an adhesive. For example, the dimple 248D may be formed of rubber or another elastic material such that the dimple 248D is deformable, while the periphery 244D may be formed of plastic, metal, or another suitable material (that is substantially rigid). In this embodiment, the periphery 244D may be welded to the interior wall 228D.

Dimple 248D may project through aperture 208D and push into engagement with sidewalls 222D defining the aperture 208D. The engagement between the dimple 248D and the sidewalls 222D may form a seal, sealing the aperture 208D.

A slit 250D may be formed at a center of the dimple 248D. The slit 250D may be an air release slit that remains closed when the dimple 248D protrudes through the aperture 208D.

During use, the dimple 248D protrudes through the aperture 208D and engages the sidewall 222D defining the aperture 208D to form a seal around the aperture 208D. The slit 250D remains closed such that heated, cooled, and/or mixed air flows through the channel 204D and bypasses the sealed aperture 208D. When the user sits on the seat 34, the user contacts the dimple 248D (and applies pressure thereto) and compresses the dimple 248D into the channel 204D. When the dimple 248D is compressed, the material of the dimple 248D stretches, opening the slit 250D into an aperture 256D in the dimple 248D. The open aperture 256D provides fluid communication between the channel 204D and the atmosphere, and the heated, cooled, and/or mixed air is free to vent/flow through the aperture 208D and to the user.

When the user stands, or gets off the seat 34, the user no longer contacts the dimple 248D (and no longer applies pressure thereto) and the dimple 248D returns to its original position, protruding through the aperture 208D. This restores the aperture 256D to the slit 250D, blocking fluid communication from the channel 204D. The heated, cooled, and/or mixed air flows through the channel 204B and bypasses the sealed aperture 208B.

Referring back to FIGS. 1 and 2, excess air from the HVAC unit 54 and seat 34 may be supplied or routed from the seat to a front of the bicycle 10. The air may be used to cool electrical complements 22 (or battery(ies)) supported by the frame 14. While the air reaching the front of the bicycle 10 is not as cool as the air leaving the HVAC unit 54, the air may still be cooler than the electrical complements 22 and may serve to transfer heat away from the electrical components 22.

For example, air leaving the HVAC unit 54 may be approximately 18° C. or less. Airflow exiting the seat 34 may be approximately 22° C. Airflow entering a space occupied by the electrical complements 22 may be approximately 25° C., and airflow exiting the space occupied by electrical components 22 may be approximately 30° C.

The channels 122 or 204 guiding the airflow from the HVAC unit 54 through the seat 34 may be either disposed in or in fluid communication with channels within the frame 14. In an example embodiment, at the front of the bicycle 10, the channels in the frame may open to disperse the air in the space occupied by the electrical components 22. In another example embodiment, an exoskeleton structure similar to the structure shown in FIGS. 5A and 5B may be in fluid communication with the channels in the frame 14 and may carry the air throughout the space occupied by electrical components 22 and cool electrical components 22 either by direct contact or by venting air through various apertures.

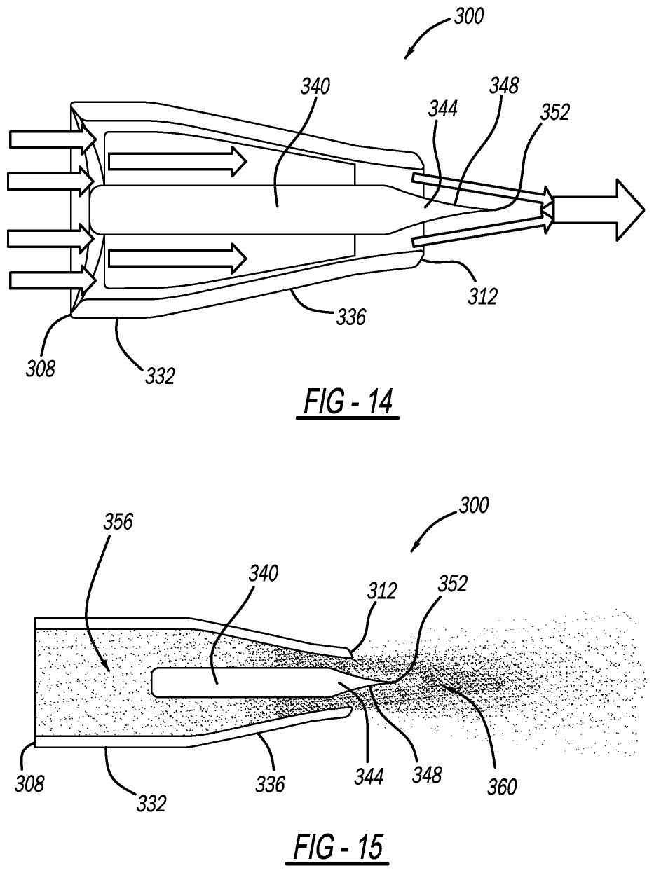

Now referring to FIGS. 12-18, heated, cooled, and/or mixed air may be routed from the HVAC unit 54 to nozzles 300. As shown in FIGS. 12-14, each nozzle 300 may include a body 304 having an inlet end 308 and an exit end 312, a core 316, and a plurality of partitions 320 defining at least one vane 324. The body 304 may define a channel 328 therein. In an example embodiment, the body 304 may be a tubular body defining a cylindrical channel 328 therein. A diameter of the channel 328 may decrease from the inlet end 308 to the exit end 312. In other words, a diameter D of the inlet end 308 may be larger than a diameter d of the exit end 312. Decreasing the diameter of the channel 328 causes an increase in velocity of the airflow. Flow is accelerated as the cross-sectional area inside the nozzle 300 decreases through the conservation of mass principle. In some embodiments, the body 304 may have a constant diameter portion 332 at the inlet end 308 and a decreasing diameter portion 336 adjacent the exit and 312.

The core 316 may be a cylindrical rod 340 having a spike 344 on an end projecting through the exit end 312. The core 316 may be formed of a metal, a plastic, a ceramic, or another suitable material. The spike 344 may have a curved sidewall 348 to center the airflow stream via a coanda effect. The coanda effect is the tendency of a fluid jet to stay attached to a convex surface. As such, the airflow stream exiting the exit end 312 will stay attached to the convex curved sidewall 348 through a point 352 to form a single high velocity, low pressure stream. The center spike 344 uses the coanda affect to direct the airflow to the center of the stream to increase the throw distance beyond the spike 344.

The core 316 extends longitudinally within the channel 328 in the body 304. More specifically, the core 316 extends through a center of the channel 328 in the body 304. The partitions 320 each connect the core 316 to the body 304. For example, the nozzle 300 may include six partitions 320 defining six vanes 324. The vanes 324 receive the airflow at the inlet end 308 and straighten the airflow through the nozzle 300. The flow is straightened by the vanes 324 running parallel to the flow. The vanes 324 reduce turbulence in the airflow which reduces diffusion of the airstream increasing the throw distance beyond the spike 344.

In use, the nozzle 300 receives an airstream at the inlet end 308 that is a low velocity, high pressure airstream. In an example embodiment, a blower (not pictured) may be used to direct airflow to the nozzle 300. The airstream is parsed into the plurality of vanes 324 in the constant diameter portion 332 where the vanes 324 straighten the airflow. The decreasing diameter portion 336 increases the velocity of the airflow as the airflow moves from the inlet end 308 to the exit end 312. The airflow stream exits the vanes 324 and stays attached to the curved sidewall 348 of the spike 344 as the airflow stream exits the exit end 312 of the nozzle 300. The exiting airflow is a high velocity, low pressure airflow. The airflow stream becomes a single stream at the point 352 directed away from the nozzle 300.

Now referring to FIG. 15, the airflow characteristics through the nozzle 300 are illustrated. As can be seen, the airflow moves from a low velocity airflow 356 at inlet end 308 to a high velocity stream 360 after exit end 312 and point 352 of core 316.

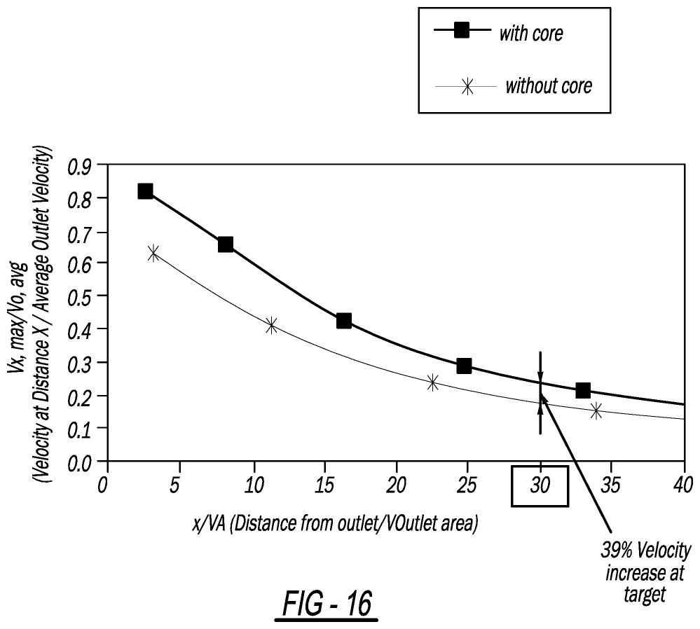

Now referring to FIG. 16, a velocity comparison between a nozzle without a core and nozzle 300 with core 316 is illustrated. The graph clearly shows that the core 316 provides a consistent increased velocity over the span of measured distances. More specifically, the nozzle 300 having core 316 provides a 39% higher velocity at the target distance.

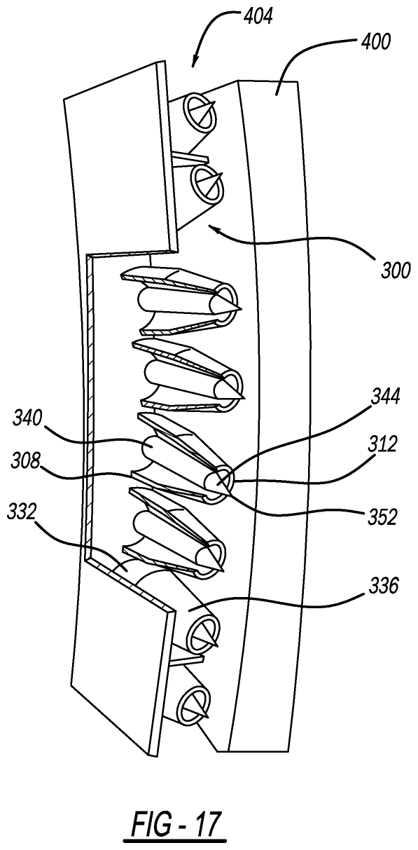

In an example embodiment, a plurality of the nozzles 300 may be disposed within windshield support sections 400 on opposing sides of the frame 14. As shown in FIG. 17, the nozzles 300 may be positioned within a channel 404 in each vertical support section 400, with the inlet ends 308 facing in a direction opposite the user and the exit ends 312 directed towards the user. For example, the nozzles 300 may be positioned linearly within the channel 404 with each inlet end 308 of the nozzle 300 contacting the inlet end 308 of an adjacent nozzle 300. The airflow through the nozzles 300 may provide heating and/or cooling comfort to the user.

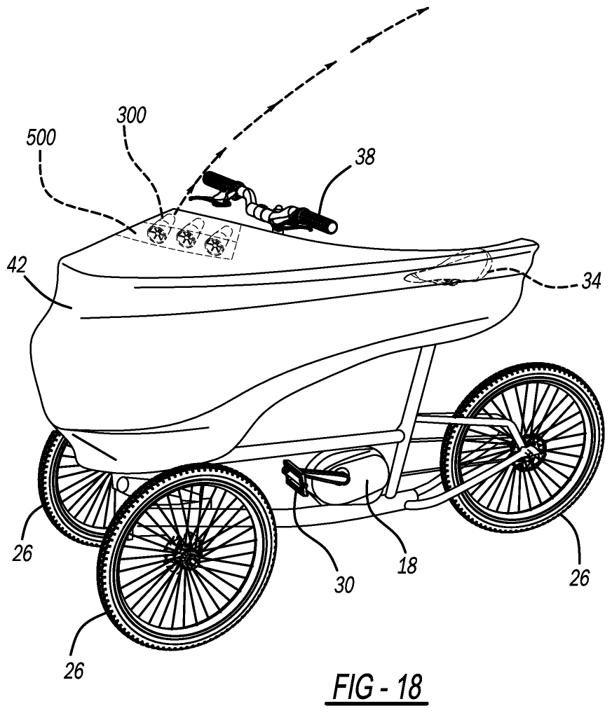

In another example embodiment, a plurality of the nozzles 300 may be disposed within a dashboard 500 section of the body 42 of the bicycle 10. As shown in FIG. 18, the nozzles 300 may be aligned along the dashboard 500 (for example, within a channel) and angled upward to blow air along a path of the windshield 46. The airflow path along the path of the windshield creates a simulated windscreen with high velocity airflow. This eliminates the need for windshield 46 in this embodiment. The simulated windshield blocks debris, such as rain, dust, insects, etc., from contacting the user. In some embodiments, the nozzle airflow speed may be adjusted or aimed to provide comfort to the occupants in times where the air curtain is not needed. For example, the velocity of the air exiting the nozzle 300 may be reduced and mist or water may be introduced into the airflow stream to create a mist for facial cooling of the user. Reduction of the airflow speed (i.e. blower speed) causes the airflow stream to not travel up and over the user, but instead be directed at a face of the user.

In an example embodiment, the nozzles 300 may be movable within the dashboard 500 such that the nozzles 300 may be configured to direct the airflow path along the path of the windshield to create a simulated windscreen with high velocity airflow and such that the nozzles 300 may be configured to be pointed at the user to cool the user.

In another example embodiment, the nozzles 300 may have a fixed position (for more reliability) within the dashboard 500. Some of the nozzles 300 may be configured to direct the airflow path along the path of the windshield to create a simulated windscreen with high velocity airflow. Others of the nozzles 300 may be configured to be pointed at the user to cool the user.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A seat having a heating, ventilation, and air conditioning (HVAC) unit attached thereto, the seat comprising:
a base having at least one channel therein, the at least one channel receiving airflow from the HVAC unit;
an aperture disposed in a surface of the base and in fluid communication with the at least one channel; and
an activation point providing selective communication through the aperture.

2. The seat of claim 1, wherein the activation point is a stopper, the stopper being engaged with a sidewall defining the aperture to prevent fluid communication through the aperture and the stopper being disengaged from the sidewall to permit fluid communication through the aperture.

3. The seat of claim 2, wherein the stopper is a ball stopper.

4. The seat of claim 2, wherein the stopper is formed of an elastic material.

5. The seat of claim 2, further comprising a biasing member for biasing the stopper into engagement with the sidewall.

6. The seat of claim 5, wherein the biasing member is a fluid-filled chamber.

7. The seat of claim 6, wherein the fluid-filled chamber includes a rubber housing.

8. The seat of claim 5, wherein the biasing member is a spring.

9. The seat of claim 8, wherein the spring is a helical spring.

10. The seat of claim 8, wherein the spring is disposed within a chamber in the stopper.

11. The seat of claim 8, wherein the spring is disposed external to the stopper.

12. The seat of claim 1, wherein the activation point is a pad containing an air release slit, the air release slit being in a closed position to prevent fluid communication through the aperture and the air release slit being in an open position to permit fluid communication.

13. The seat of claim 12, wherein the pad includes a dimple, the air release slit being disposed at a center of the dimple.

14. The seat of claim 13, wherein the dimple projects through the aperture, the dimple contacting a sidewall defining the aperture to create a seal between the dimple and the sidewall, the dimple being biased to project through the aperture to prevent airflow from flowing through the aperture.

15. The seat of claim 14, wherein when the dimple is compressed, the air release slit opens into an aperture, permitting fluid communication therethrough.

16. The seat of claim 12, wherein a periphery of the pad is fixed to an inner wall of the at least one channel around a sidewall defining the aperture.

17. The seat of claim 1, further comprising a plurality of the aperture and a plurality of the activation point.

18. The seat of claim 17, further comprising a seat back including a portion of the plurality of the aperture and a portion of the plurality of the activation point.

19. A bicycle comprising:
a frame;
a seat supported by the frame; and
a self-contained heating, ventilation, and air conditioning (HVAC) unit supported by the frame and providing airflow to the seat,
the seat including
a base having at least one channel therein, the at least one channel receiving the airflow from the HVAC unit,
an aperture disposed in a surface of the base and in fluid communication with the at least one channel, and
an activation point providing selective communication through the aperture.

20. A bicycle comprising:
a frame;
a seat supported by the frame; and
a self-contained heating, ventilation, and air conditioning (HVAC) unit supported by the frame and providing airflow to the seat,
the seat including a base having at least one channel therein, the at least one channel receiving the airflow from the HVAC unit, the base being formed of an exoskeleton frame.
